(19) United States
(12) Patent Application Publication
(10) Pub. No.: US 2026/0268043 A1
(43) Pub. Date: Sep. 10, 2026

(54) ECOSYSTEM ATTRIBUTE SIMULATION MODELS

(71) Applicant: Indigo Ag, Inc., Charlestown, MA (US)

(72) Inventors: Charles D. BRUMMITT, Seattle, WA (US); Hamze DOKOOHAKI, Madison, WI (US); Ashok A. KUMAR, Malden, MA (US); Mark J. EASTER, Fort Collins, CO (US); Brian SEGAL, Washington, DC (US); Christopher K. BLACK, Santa Barbara, CA (US); Jeffrey J. KENT, Seattle, WA (US)

(21) Appl. No.: 19/165,539

(22) PCT Filed: Mar. 15, 2024
(86) PCT No.: PCT/US2024/020134

§ 371 Date: Sep. 15, 2025

Related U.S. Application Data
(60) Provisional application No. 63/452,547, filed on Mar. 16, 2023.

(51) Int. Cl. G06F 30/27

(52) U.S. Cl. CPC G06F 30/27

(57) ABSTRACT

An application determines, for a first given time, first latent states for a geographic region. The application obtains one or more measurements for one or more ecosystem attributes for the geographic region. Following an intervention, the application determines, at a second given time following the first given time, second latent states for the geographic region. The application obtains one or more post-intervention ecosystem attributes by applying the one or more measurements and the second latent states to a model configured to output one or more estimated ecosystem attributes for the geographic region. The application updates the first latent states using the post-intervention estimated ecosystem attributes and determines a counterfactual latent state for the region using the updated first latent states. The application generates, based on the counterfactual latent state, a simulation for the geographic region that simulates counterfactual ecosystem attributes for a scenario where the intervention had not occurred.

### CROSS-REFERENCE TO RELATED APPLICATIONS

This application claims the benefit of and priority to U.S. Provisional Application No. 63/452,547, filed on Mar. 16, 2023, the contents of which are hereby incorporated by reference in their entirety.

### TECHNICAL FIELD

This disclosure relates generally to quantifying emissions in geographical regions (e.g., fields), and, in particular, to systems and methods for simulating ecosystem attributes to determine, e.g., impacts of interventions.

### BACKGROUND

Efforts to quantify ecosystem attributes (e.g. greenhouse gas emissions) in geographical regions (e.g., sourcing regions and farms comprising fields and/or forests), are increasingly relying on a combination of measurements taken on the ground and model predictions. Measurements alone can be unviable because they are too infrequent and operationally expensive or otherwise impractical to be cost-effective, or because they are frequent yet too noisy or measure too small a portion of the biological pool of interest (e.g., just the top layer of soil, or just the canopy). Using models alone, without taking measurements, may not result in enough trust and confidence in the predictions, given that ecosystems services are so heterogeneous and so hard to predict. Measurements may be used with models in a number of ways, including when the measurement is used to re-initialize the model so that its prediction precisely equals the measurement (thereby ignoring the model's prediction up to that point) or to assess the model's predictive performance. However, simply updating the internal state of a model so that its prediction equals a measured value can perturb models by unrealistically large amounts that are inconsistent with the model's prediction, especially if measurements with a large uncertainty range (e.g. noisier, cheaper technologies) are used. These methods also fail to efficiently leverage all of the existing information as they ignore the information in the model prediction (in the case of re-initializing) or ignore the uncertainty in the measurement (in the case of merely assessing the model's accuracy).

### SUMMARY

Systems and methods are disclosed herein for predicting the impact of interventions taken with respect to geographical areas. For example, the systems and methods disclosed herein may be used to determine the impact of changes to farming practices on greenhouse gas emissions from agricultural soils. The present disclosure describes methods for data assimilation to quantify causal impacts of interventions in situations without randomized trials where models are used to quantify the counterfactual. These methods have applications in simulating various intervention impacts in natural and managed ecosystems, including, for example, sequestration of carbon dioxide, abatement of greenhouse gas emissions, water quality, and biodiversity.

At least some of the systems and methods are disclosed herein are for estimating ecosystem attributes. In some embodiments, estimates are obtained of a probability distribution for latent states of a model of an ecosystem at an initial point in time, and the model simulates the changes in those latent states over time. An intervention may be applied to the ecosystem, at which time the sequence of latent states splits into two sequences, one for the actual world with the intervention, and one for the counterfactual world without the intervention. One or more attributes of the ecosystem are measured one or more times, before, during, and/or after the intervention. Uncertainty of the measurements may be estimated. A probability distribution for the predictions of those measured quantities may be calculated from the probability distribution for the latent states of the model. The probability distribution for the latent states in the actual world (the one with the intervention) is updated based on the distribution for the measurement and the distribution for the model's predicted values for the measurement. This update to latent states may proceed backward in time and forward in time. The updates to the latent state at the time of the intervention may then be propagated forward in time in the sequence of latent states for the counterfactual world that lacks the intervention. A probability distribution for the ecosystem attribute of interest (e.g., carbon stocks, water quality) may be calculated from the latent states (and this attribute may or may not be the same as the attribute of the ecosystem that was measured), for both sequences of latent states (the one for the actual world and the one for the counterfactual world). The impact of the intervention on the ecosystem attribute of interest may be obtained by subtracting the ecosystem attribute of interest obtained from the actual and counterfactual sequences of latent states. Uncertainty of the impact may be obtained from the probability distribution and may be reduced with more measurements.

In some embodiments, an ecosystem attribute tool obtains, for a first time, a prediction of latent states of a model at the time of an intervention (e.g., a change in farming or forestry practices) in a geographical region. After the intervention, the ecosystem attribute tool simulates the ecosystem (i.e., updates the latent model states) with the intervention, and the ecosystem attribute tool simulates the ecosystem without the intervention, producing two sets of latent states in the model. A measurement is taken of an attribute of the system, and uncertainty of the measurement is estimated. The ecosystem attribute tool compares the measurement with the model's prediction of the measurement for the case of the intervention. The ecosystem attribute tool updates the model's latent states so that the model's prediction of the measurement is closer to the measured value. The ecosystem attribute tool then updates previous and subsequent latent states to be consistent with new values of the latent states at the time of the measurement. Once the latent state at the time of the intervention is updated, the ecosystem attribute tool updates the values of the latent states for the second simulation of the counterfactual world that lacks the intervention.

Optionally, measurements that precede the intervention are used to update the model's latent states at the time of the measurement and at times before and after the measurement. The ecosystem attribute tool can repeat this process of measurement and model update (backward in time and forward in time for the actual world containing the invention; and backward in time and then forward in time for the counterfactual simulation that lacks the intervention) an arbitrary number of times, and the measurements can have an arbitrary number of types (e.g., one measurement can be a soil measurement, another a canopy greenness measurement).

### BRIEF DESCRIPTION OF THE DRAWINGS

The accompanying drawings, which are incorporated into and constitute a part of this specification, illustrate various exemplary embodiments and together with the description, serve to explain the principles of the disclosed embodiments.

FIG. 1 is an exemplary computing node, according to embodiments of the present disclosure.

FIG. 2A is a diagram of estimated soil carbon stock and associated uncertainty at a point, according to embodiments of the present disclosure.

FIG. 2B is a diagram of estimated soil carbon stock and associated model and measurement uncertainty at a point, according to embodiments of the present disclosure.

FIG. 3 depicts a Kalman filter, according to embodiments of the present disclosure.

FIG. 4 is an illustration of an ensemble filter that uses a model for forecasting, according to embodiments of the present disclosure.

FIG. 5 is a graph of conditional probabilities of the time-series of latent states zₜ, measurements yₜ, and inputs uₜ, according to embodiments of the present disclosure.

FIG. 6A is a graph illustrating the effect of using a Bayesian filter, according to embodiments of the present disclosure.

FIG. 6B is a graph illustrating the effect of using a Bayesian smoother, according to embodiments of the present disclosure.

FIG. 7 is an illustration of a model using a counterfactual and intervention, according to embodiments of the present disclosure.

FIG. 8A is a graph illustrating the status quo of transforming time-series into pairs of prediction tasks.

FIG. 8B is a graph illustrating training on an entire time-series of one or more observations using Bayesian filters/smoothers, according to embodiments of the present disclosure.

FIG. 9 is a graph illustrating a difference in model predictions, according to embodiments of the present disclosure.

FIG. 10 is a graph illustrating differences in causal impact, according to embodiments of the present disclosure.

FIG. 11 illustrates one embodiment of a system environment for implementing an ecosystem attribute tool, in accordance with an embodiment.

FIG. 12 illustrates one embodiment of exemplary modules and databases used by the ecosystem attribute tool, in accordance with an embodiment.

FIGS. 13A-D are a sequential illustration of a model using a counterfactual and intervention with smoothing applied between steps of the sequence, according to embodiments of the present disclosure.

FIG. 14 is an illustrative flowchart showing a process for estimating ecosystem attributes, in accordance with an embodiment.

### DETAILED DESCRIPTION

Reference will now be made in detail to the exemplary embodiments of the present disclosure, examples of which are illustrated in the accompanying drawings. Wherever possible, the same reference numbers will be used throughout the drawings to refer to the same or like parts.

The systems, devices, and methods disclosed herein are described in detail by way of examples and with reference to the figures. The examples discussed herein are examples only and are provided to assist in the explanation of the apparatuses, devices, systems, and methods described herein. None of the features or components shown in the drawings or discussed below should be taken as mandatory for any specific implementation of any of these devices, systems, or methods unless specifically designated as mandatory.

Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

As used herein, the term “exemplary” is used in the sense of “example,” rather than “ideal.” Moreover, the terms “a” and “an” herein do not denote a limitation of quantity, but rather denote the presence of one or more of the referenced items.

Methods of quantifying ecosystem attributes (e.g., carbon sequestration, carbon intensity of an agricultural product, greenhouse gas emissions, water quality, water use, nitrogen use, biodiversity, yield of agricultural production (e.g. a measure of grain produced per acre, a dressing percentage livestock, biomass produced per acre, biofuel production per unit of input, etc.), soil characteristics, etc.) are increasingly relying on a combination of measurements and model predictions to quantify outcomes accurately. Ecosystem attributes may include any attribute of an agricultural production system, and can refer to any or all of an outcome variable and an attribute that is measured. Using measurements of ecosystem attributes alone, without simulating the ecosystem using models, can be unviable because measurements are too infrequent, too expensive, or too noisy, or because they measure too small a portion of the biological pool of interest (e.g., they measure just the top layer of soil or just the canopy of the forest). Conversely, using models alone, without taking measurements, may not result in enough trust and confidence in the predictions when ecosystems attributes are heterogeneous and hard to predict. The ecosystem attribute simulator application discussed herein employs hybrid approaches that exploit measurements and models.

Embodiments of the present disclosure focus on predicting impacts of changes to farming practices on emissions in agricultural soils, but the methods can be applied to predicting effects of interventions on other ecosystem attributes in a variety of applications, including plant and animal agriculture and forestry. Existing methods for combining soil measurements with models (for example, biogeochemical process models) have largely been limited to setting initial conditions. The perceived wisdom is to initialize the model at an initial measurement and tune the model's parameters so that the model accurately predicts a subsequent measurement. In some embodiments, measurements taken after the initialization of the model are either ignored (and used only to evaluate the model's performance), or they are used to re-initialize the model by “brute force.” These approaches ignore the uncertainty of measurements, thereby limiting the ability to use cheap, noisy measurement technologies (which would otherwise perturb the model significantly, leading to erratic model behavior, or leading to erroneous conclusions that models were under-estimating their uncertainty because the models were trained on accurate, expensive measurements but tested on noisy, inexpensive measurements). These prevailing approaches can also lead to less accurate predictions, because they initialize a model using a measurement by updating some of the model's state variables but not the other state variables that strongly covary with them. The broader goal of “grounding” models of ecosystems using expensive “gold standard” measurements has created inefficiencies by disregarding measurement uncertainty that, when properly addressed, enables more accurate predictions through use of more diverse measurement methods, including those with higher frequencies of collection and larger uncertainty values (for example, satellite imagery).

Embodiments of the present disclosure describe how to assimilate measurements with models of soil biogeochemistry and how these techniques can lead to improvements in the accuracy of predictions of ecosystem attributes. These techniques enable use of inexpensive, noisy measurements that are otherwise problematic when combined with models. The described methods can exploit a variety of measurements of different types (e.g., measurements of carbon concentration in soil samples, remote sensing of plant growth, measurements of crop yield, reflections from ground penetrating radar, changes in apparent electrical conductivity from electromagnetic induction sensors, gas exchange, evaporation, and energy flux from eddy-covariance flux towers, etc.). Additionally, these methods can be run efficiently using modern computing libraries for automatic differentiation and probabilistic programming, on hardware ranging from CPUs to GPUs to TPUs.

Embodiments of the present disclosure also show how data can be assimilated in ways that improve predictions of counterfactual outcomes, enabling improvements to quantifying impacts of interventions in a variety of domains. In some embodiments, quantifying impacts of interventions may be performed by conducting randomized trials, with parts of an ecosystem maintained as control plots. However, for some ecosystems such as commercial farms or forests, randomized trials are prohibitively difficult or costly, and models are used to simulate the counterfactual outcomes. The field has avoided data assimilation out of concern that assimilating measurements of observed outcomes would address bias in observed outcomes, but similar bias in counterfactual outcomes could not be addressed. Embodiments of the present disclosure present methods for using measurements of the observed outcomes to improve predictions of the counterfactual outcomes in ways that address this concern about bias.

Alternative methods for combining soil measurements with models have been limited to setting initial conditions. In some embodiments, one may manually tune parameters of the model to closely approximate the measurements, or may initialize the model at an initial measurement and tune parameters so that the model accurately predicts a subsequent measurement. However, in these cases, measurements taken after the initialization of the model are either ignored (and used only to monitor the model's performance) or are used to re-initialize the model. These approaches ignore the uncertainty of measurements, thereby limiting the ability to use cheap, noisy measurement technologies (which would otherwise perturb the model significantly, leading to erratic model behavior). Additionally, these approaches lead to inaccurate predictions in some circumstances because they initialize a model using a measurement by updating some of the model's state variables but not the other state variables that strongly covary with them.

One conflict arising from data assimilation in a project scenario (the observed world in which an intervention is made) is how to ensure bias is not created by correcting bias in one scenario that is also present in the baseline scenario (the counterfactual world in which the intervention is not made). To test whether this conflict occurs, data assimilation is performed in computational experiments by assimilating post-intervention project-scenario observations and using them to update baseline-scenario predictions. The bias in the estimate of the impact of the intervention is calculated for the case of post-intervention data assimilation enabled and for the case of post-intervention data assimilation disabled. This process can be repeated for multiple, random splits of the data into training and test sets, so that multiple estimates of the two biases can be estimated. The concern that assimilating post-intervention, project-scenario measurements creates bias in estimates of the intervention's impact is then tested by comparing the distributions of the bias estimates with and without assimilation of post-intervention measurements.

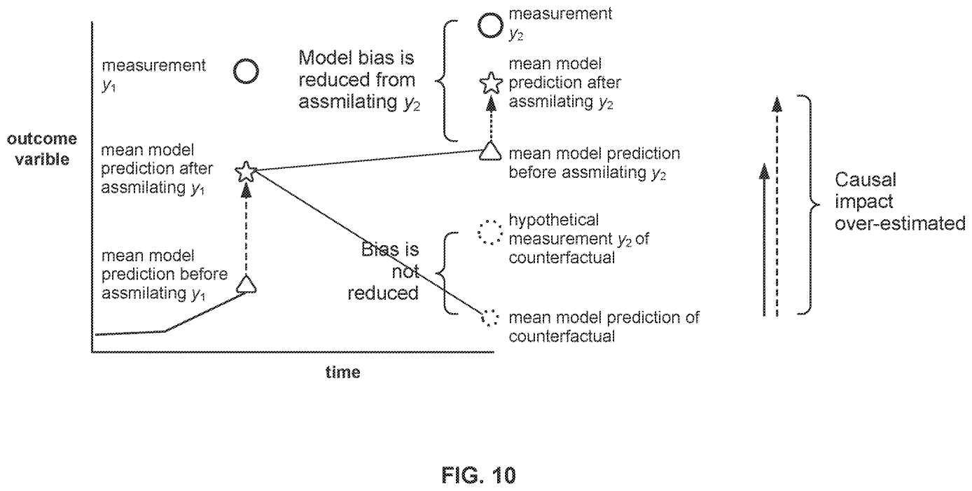

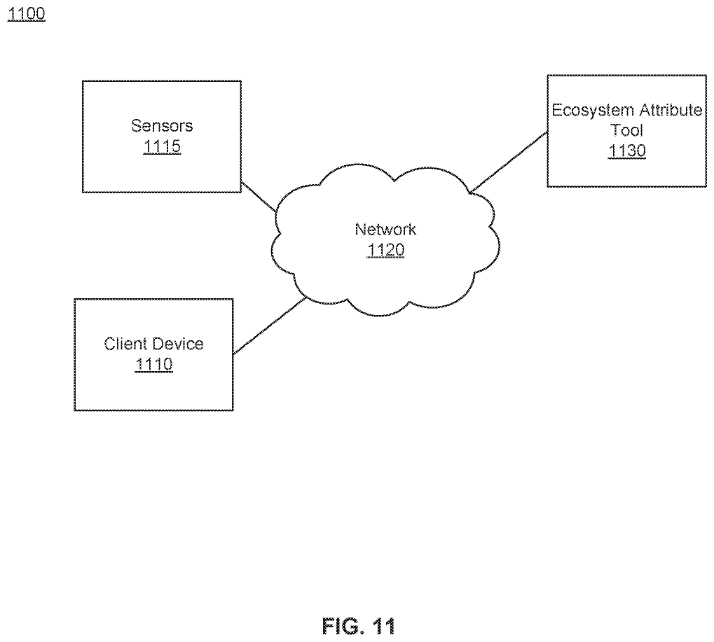

Each time-series of observations (i.e., measurements) of an ecosystem attribute occurs at arbitrary times (t₀, t₁, t₂, . . . ). Between measurements, the model simulates the ecosystem using a timestep that is typically more brief than the amount of time between successive observations. Simple methods split up multi-observation time-series into pairs of initial measurement and measurement some number of years later (that is, (t₀, t₁), (t₀, t₂), (t₀, t₃) . . . ), and measurements at intermediate times are ignored. Data assimilation, by contrast, performs model updates at all the available measurements are taken (t₀, t₁, t₂, . . . ), as depicted in FIG. 8.

Current models of agricultural soil carbon either do not consider ground-truth measurements or make simple replacements of modeled values with ground-truth measurements, creating issues in some circumstances and missed opportunities. For example, some such approaches essentially overwrite these models' estimates of the carbon stock with an initial measurement of the carbon stock. That overwriting perturbs the model far out of equilibrium, leading to potentially inaccurate estimates of temporal changes in carbon stocks.

Prior approaches add draws from a random variable to the output of a model to capture the uncertainty in the model's predictions. Assumptions are then made about how the variance of such random variables increases with the time since the most recent measurement. The methods proposed here take a different approach: the internal (i.e., latent) states of the model are assumed to be random. These random variables for internal states are fed to the model's prediction logic, creating a new random variables for the internal states at the next time step. Growth of uncertainty over time then emerges from the process model. The uncertainty of the internal states is then used to assimilate measurements. For example, to blend measurement and prediction for a model such as DayCent where three conceptual carbon pools are among the internal state variables, the variance of the carbon stock pool fractions is estimated. It is expected that the variance of the total of these pool fractions slowly increases as time elapses and then decreases as measurements are taken and assimilated.

There are two ways by which random variation is introduced in the internal states of the model. One way is that the initial conditions for the method's internal state variables are random. Another way is that noise is added to internal states at each time-step. The variance of this noise is often called “process variance” or “innovation variance”.

Embodiments of the present disclosure can solve the problems described above with respect to ground-truth measurements and significantly improve accuracy and reduce costs by pursuing data assimilation. The idea is to update the internal state variables of DayCent (or another model) given a measurement. The result of this update is that the new prediction of the measurement lies between the original prediction of the model and the measurement. This updating can apply to more internal state variables than just the soil carbon stocks; instead, this update can comprise a Bayesian update of all internal states of the model, so that the model's state remains internally consistent.

The benefits of embodiments of the present disclosure may be significant. These benefits may include:
1. Solving the issues present in initializing models at the first measurement, which is perturbing current models out of equilibrium and leading to inconsistent internal model states. Perturbing the model out of equilibrium can lead to inaccurate predictions of temporal changes of stocks because the model seeks to return to its equilibrium, but if the measurement was far from the equilibrium, then the equilibrium was likely inaccurate. Accurate estimates of temporal changes in stocks enables estimation of removals of carbon dioxide from the atmosphere via “stock-change accounting” (that is, if carbon stocks in the soil increase over time, then carbon dioxide was probably removed from the atmosphere).
2. Enabling re-measurements (i.e., measurements of carbon stocks after the initial measurement) to reduce uncertainty by “pinching” the envelope of uncertainty around stocks in the project scenario. Also, this reduction in uncertainty can happen efficiently: usually, models that are used for carbon offsets need expert review when they are updated, but a method to update the model's state variables given a measurement can be reviewed by an expert once and then deployed in a program, without the need for expert review each time a measurement is taken and the model's state variables are updated. By contrast, alternative approaches that merely use measurements to evaluate a model's performance do not pinch the envelope of uncertainty at a re-measurement because they ignore the re-measurement when making predictions. And alternative approaches that do a brute-force re-training of the model given re-measurements are expensive because it involves writing a new validation report that must be reviewed by experts.
3. Unlocking the use of computationally inexpensive measurement tools such as penetrometers, spectrometers, and remote sensing. With data assimilation, the precision of the measurements of ecosystem attributes (e.g., soil carbon) is quantified, and that prevision is provided as input to the data assimilation. If measurements are sufficiently cheap, then even a low signal-to-noise ratio could be preferred over a high signal-to-noise ratio. Many models today are trained on measurements taken with expensive methods with low uncertainty. Without data assimilation, it becomes difficult to later switch to cheaper, noisier measurement methods, for two reasons. First, there is risk that cheaper, noisier measurement methods raise a false alarm in a test of the model's predictive accuracy on the new measurements. Second, cheaper, noisier measurement methods could also raise a false alarm about a model's uncertainty being poorly-calibrated: the new, noisier measurements could indicate that model uncertainty had been under-estimated, but that could be due to the measurement method changing to a noisier one. The value of adopting a new measurement method can be quantified by the extent to which its precision leads to more precise model predictions.

One clarification to alternative methods is that the Bayesian filter/smoother (i.e., the system that assimilates measurements with a model) is what undergoes calibration and validation. The Bayesian filter/smoother is deployed on the calibration dataset and does its usual predict-update procedure on the calibration data. Therefore, the filter/smoother must pass the requirements for accuracy and well-calibrated uncertainty, and the report asserting that is reviewed by an expert before deployment.

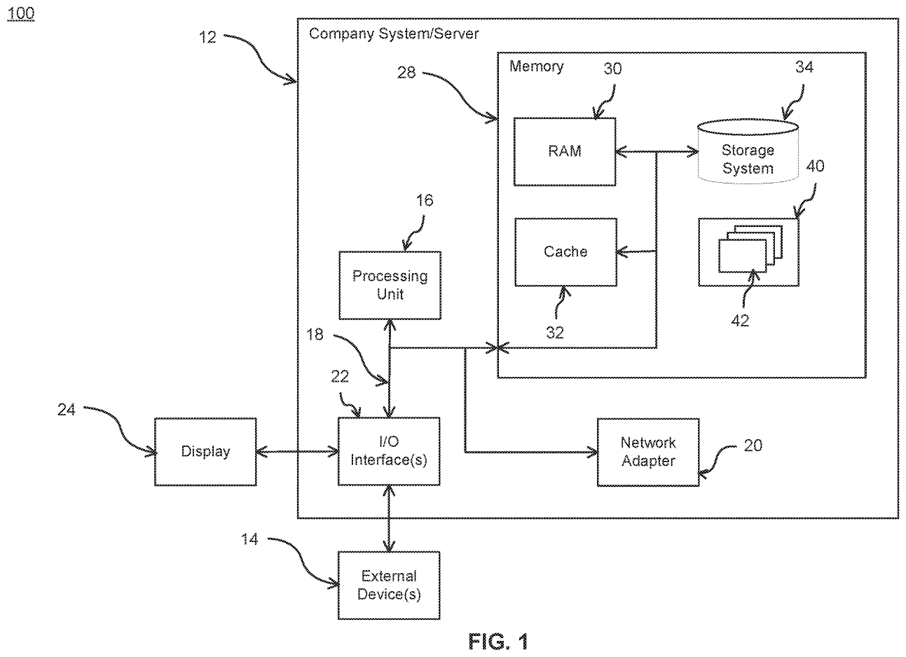

Referring now to FIG. 1, a schematic of an example of a computing node is shown. Computing node 10 is only one example of a suitable computing node and is not intended to suggest any limitation as to the scope of use or functionality of embodiments described herein. Regardless, computing node 10 is capable of being implemented and/or performing any of the functionality set forth hereinabove.

In computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 1, computer system/server 12 in computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, Peripheral Component Interconnect (PCI) bus, Peripheral Component Interconnect Express (PCIe), and Advanced Microcontroller Bus Architecture (AMBA).

Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the disclosure.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

The present disclosure may be embodied as a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

Combining Measurement with a Model Prediction

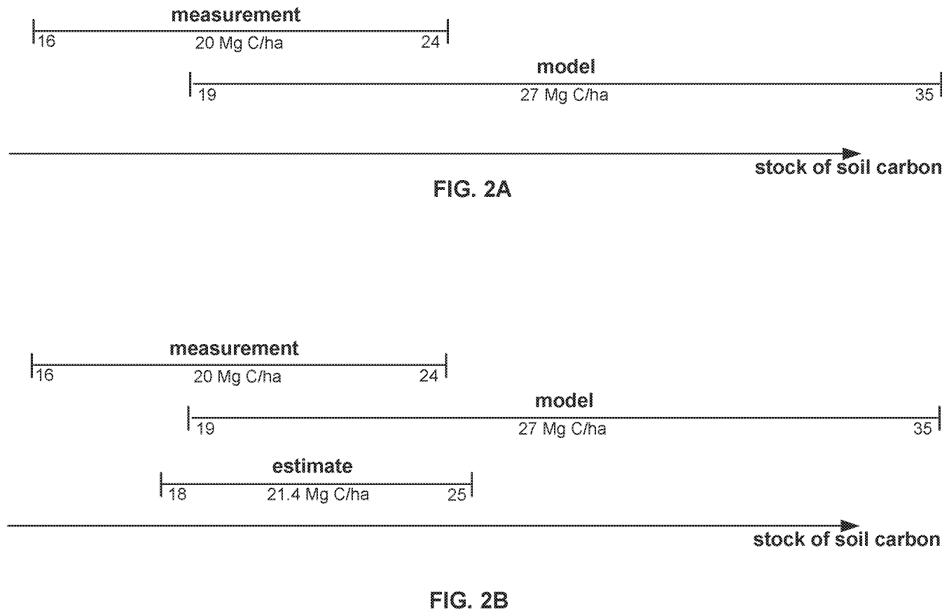

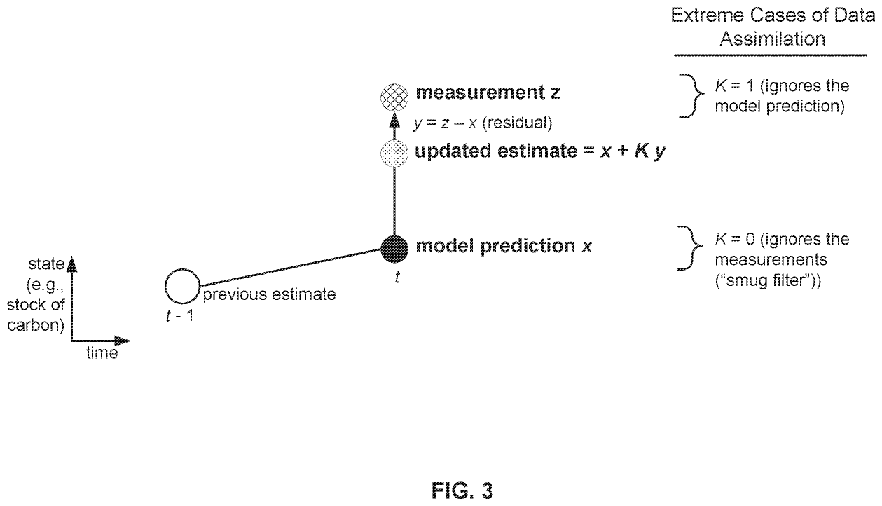

Suppose there are two estimates of an ecosystem attribute (e.g., soil carbon stock) at a point, one from a measurement and another from a model, as depicted in FIG. 2A. The error bars within the graph indicate that the measurement is very precise, while the model is more uncertain.

The measurement is more precise than the model, so the true value is likely closer to the measured value (20 Mg C/ha) than to the model's prediction (27 Mg C/ha). The two error bars overlap, so it's likely that the true value lies somewhere near that region of overlap.

An exemplary result of data assimilation is shown by the estimate in FIG. 2B. Here, the result is 21.4 Mg C/ha, closer to the measurement than the model. The uncertainty of the new estimate is lower than for either the measurement or the model. By combining the two estimates, uncertainty is reduced. The usage of stock of soil carbon in FIG. 2A and FIG. 2B is merely exemplary; any ecosystem attribute may be measured and/or modeled in similar fashion, whose values may be combined to reduce uncertainty.

### Visualizing the Status Quo

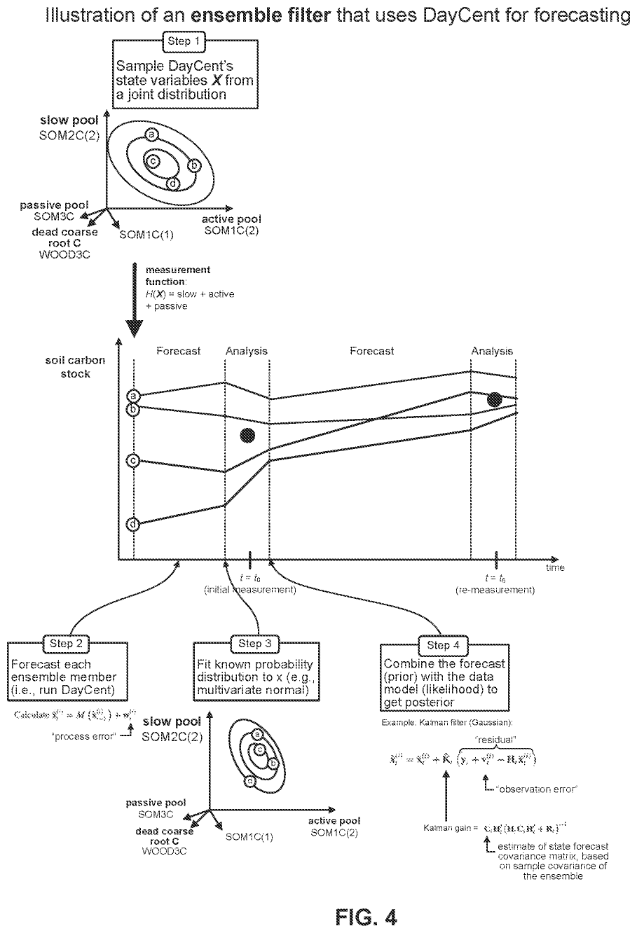

FIG. 3 depicts a Kalman filter, which is a simpler approach to data assimilation that makes assumptions about Gaussian distributions and linearity. However, the Kalman filter begins to illustrate the idea of a “Bayesian filter,” a computational method that, given a measurement, updates the model's state at the time of the measurement (but not model's state at earlier points in time). Moreover, it illustrates how the status quo consists of two extreme cases. First, an alternative method for using initial measurements of carbon is to completely ignore the model prediction and update the state of the model to exactly equal the measured value. This approach is analogous to taking K=1 in the graph depicted in FIG. 3. Second, an alternative method for using re-measurements is to ignore them and rely entirely on the model for making predictions. This corresponds to the other extreme in the graph depicted in FIG. 3, where K=0. In the case of modeling soil carbon stocks, this choice implies that measurements are only used to evaluate the accuracy of the model and to tune the parameters of the model when it is trained on a large training dataset; measurements are not used to improve an individual simulation of the model using measurements taken at the particular geographic region that is being modeled.

There are multiple methods for implementing Bayesian filters. An ensemble filter generally works well with nonlinear models and is not too computationally intensive, as it makes distributional assumptions about the random variables for the internal state variables. Alternatively, a particle filter involves a Monte Carlo approach, which can capture arbitrary distributions but is more computationally expensive and can require.

Visual Summary of how a Filter Using a Model for the Forecasting Step would Work

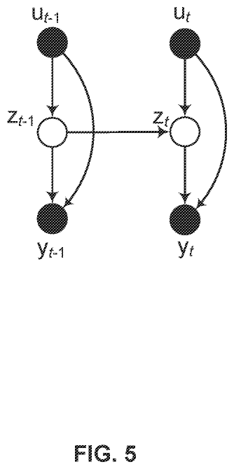

FIG. 4 is an illustration of an ensemble filter that uses a model for forecasting. This method takes a small number of draws from a distribution over the model's state variables (step 1), simulates forward in time until a ground-truth measurement is taken (step 2), and updates the state variables based on their covariance with the measured quantity (steps 3 and 4). Notably, even variables not directly measured are updated in step 4.

Ideally, all state variables associated with, e.g., soil carbon (as depicted, but applies to any other ecosystem attribute) are updated. A direct measurement of state variables is not needed in the model; for example, the total stock of soil carbon can be measured, although the model has multiple pools of soil carbon. Unobserved state variables can be inferred based on the covariance with the variables that are measured.

### State-Space Models

Embodiments of the present disclosure include methods using the technique of state space models. In a common formulation, these models consider a sequence of latent variables zₜ which are affected by inputs uₜ (which may be interventions by land managers). For ecosystems, the latent variables zₜ may be internal state variables of a model that simulates the ecosystem. The observations yₜ of the system depend on the latent variable zₜ and on the input uₜ. It is common to make zₜ expressive enough that it implicitly captures all the information in previous observations y_{1:t-1}. The joint distribution of the model factorizes as the product of the prior over latent states p(zₗ|uₗ), the dynamics of the latent state variables p(zₜ|zₜ₋₁, uₜ), and the probability p(yₜ|zₜ, uₜ) of the measured value given the latent state variables zₜ (and possibly also the input uₜ):

$$p ( {y}_{1 : T} , {z}_{1 : T} \vert {u}_{1 : T} ) = [ p ( {z}_{1} \vert {u}_{1} ) {{\prod }_{t = 2}}^{T} p ( {z}_{t} \vert {z}_{t - 1} , {u}_{t} ) ] [ {{\prod }_{t = 1}}^{T} p ( {y}_{t} \vert {z}_{t} , {u}_{t} ) ]$$

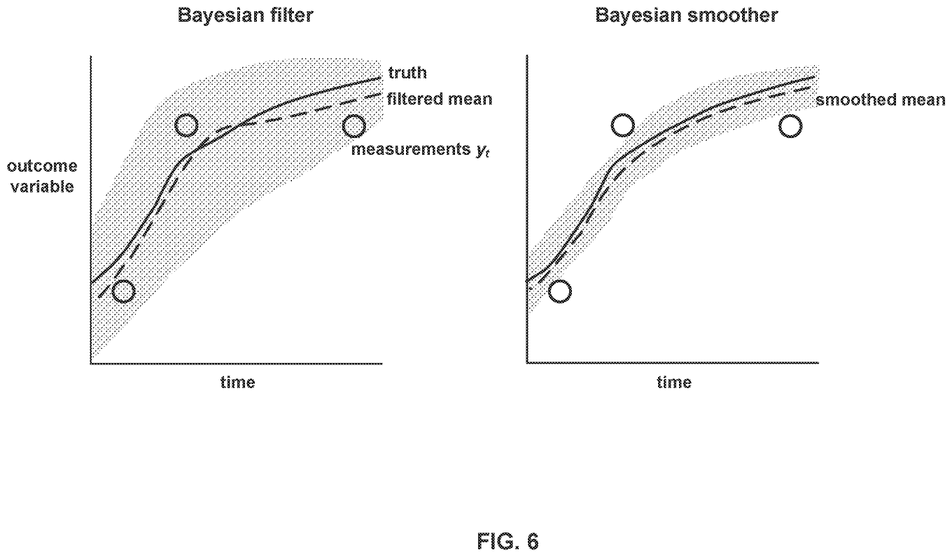

These conditional probabilities can be represented in graphical form as shown in FIG. 5. FIG. 5 depicts a state-space model represented as a graphical model. zₜ represents the hidden variables at time t, yₜ represents observations (outputs), and uₜ represents optional inputs.

In many cases, it is reasonable to assume that process errors and measurement errors are normally distributed, so the equations can be written as:

$${z}_{t} = f ( {z}_{t - 1} , {u}_{t} ) + 𝒩 ( 0 , {Q}_{t} )$$

$${y}_{t} = h ( {z}_{t} , {u}_{t} ) + 𝒩 ( 0 , {R}_{t} )$$

where the (deterministic) function ƒ specifies the dynamics of the state variables, and h is the measurement function (also deterministic). However, the methods presented here do not require that process and measurement errors be Gaussian-distributed.

### Example 1: Measuring Carbon Sequestration in Soil

To measure carbon sequestration in soil using stock-change accounting, yₜ is the carbon stock at time t at some location to some specified depth (in units of Mg C per hectare), and zₜ is the carbon stocks in various states in the model (e.g., slow and labile pools) together with other variables describing the soil. The inputs uₜ are inputs to the soil, including weather, solar radiation, and management practices (e.g., planting, tillage, fertilizer application, harvest). The measurement function h grabs the carbon pools in the state variable zₜ and adds them together. The ecosystem attribute of interest in this example is the cumulative temporal change in carbon stocks, y_{T}−y₀, over the time interval [0, T], which estimates the amount of carbon removed from the atmosphere.

The latent state dynamics ƒ could be a process model (such as Roth C, DNDC, DayCent, etc.) that exploits knowledge about biogeochemical processes to simulate changes in soil attributes. Alternatively, ƒ could be an empirical model that does not exploit known physical relationships but rather models the behavior phenomenologically (e.g., ARIMA models, neural networks). Further discussion of process models (e.g., DayCent and others) is disclosed in U.S. Pat. No. 11,592,431, granted on Feb. 28, 2023, filed as U.S. patent application Ser. No. 17/724,912 on Apr. 20, 2022, and entitled “Addressing Incomplete Soil Sample Data in Soil Enrichment Protocol Projects,” the disclosure of which is hereby incorporated by reference herein in its entirety. Wherever such models are mentioned, the disclosure of this process model reference carries full force and effect.

### Inferential Goal 1: Estimate the Total of an Ecosystem Attribute Across a Time Period, Given One or More Measurements

Given the measurements y_{1:t}, one is interested in estimating the total of an ecosystem attribute over time [0, T]. Without loss of generality, it can be assumed (as in the soil example above) that the ecosystem attribute of interest is a function of the observations y₀, y₁, . . . , y_{T}, such as the cumulative change in the observations y_{T}−y₀ for the case of estimating the change in carbon stocks. But the methods can also be applied to cases where the observations are different from the ecosystem attribute of interest (e.g., one observes yield of grain but wishes to quantify carbon sequestration). The ending time T may not be the same as the date of the latest measurement t because measurements may be expensive and done infrequently, while markets wish to reward ecosystems services quickly (e.g., annually or quarterly).

### Bayesian Filtering and Smoothing

To solve this task of quantifying ecosystem attributes using state space models, Bayesian filtering is used, which recursively computes the latent variables zₜ using a predict-update cycle. The prediction step calculates the predictive distribution for the latest state zₜ given the previous measurements y_{1:t-1} and inputs u_{1:t-1}. This predictive distribution then becomes the prior for the update step, which uses Bayes' rule to compute the distribution for zₜ given measurements y_{1:t} and inputs u_{1:t}.

Bayesian filtering updates the beliefs about the present using all measurements of the past. However, for many ecosystems attributes of interest, the goal is to quantify the total of the ecosystem attribute integrated across time (e.g., total carbon sequestration) or the change in the ecosystem attribute (e.g., change in water quality, change in biodiversity). For those tasks, the more relevant method is Bayesian smoothing, which computes the beliefs about the ecosystem at a point in time based on all available measurements from past and future. That is, whereas Bayesian filtering recursively computes the beliefs about the internal state zₜ given all previous measurements and inputs that precede the time t of interest, Bayesian smoothing uses all measurements available, including measurements taken after the time t of interest. Said differently, Bayesian filtering is an online algorithm that refines the belief state using historical data, whereas Bayesian smoothing is an offline algorithm that computes the beliefs about the state variables given all measurements and inputs available from the past and future.

The key idea here is that Bayesian smoothing can reduce uncertainty of early measurements. That makes it useful for quantifying ecosystem attributes that are cumulative (e.g., total carbon sequestration) or are changes (e.g., change in biodiversity).

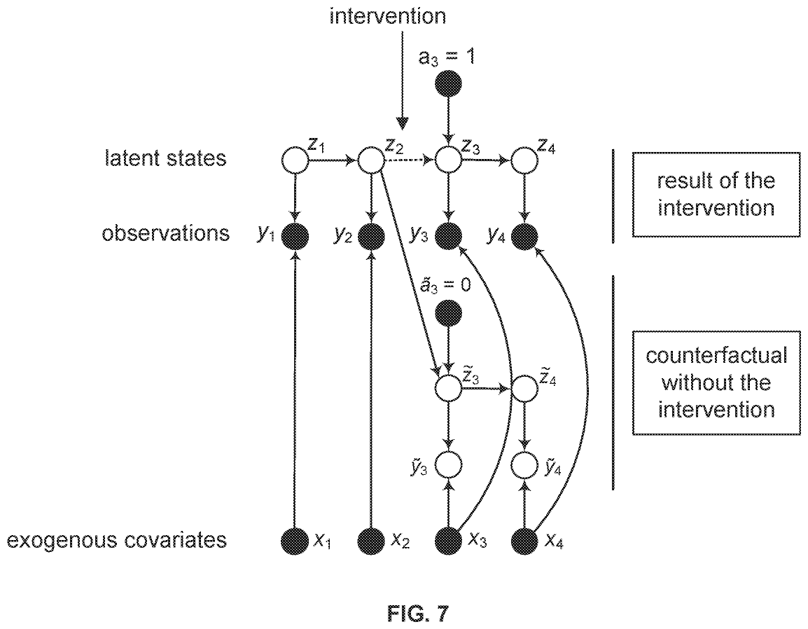

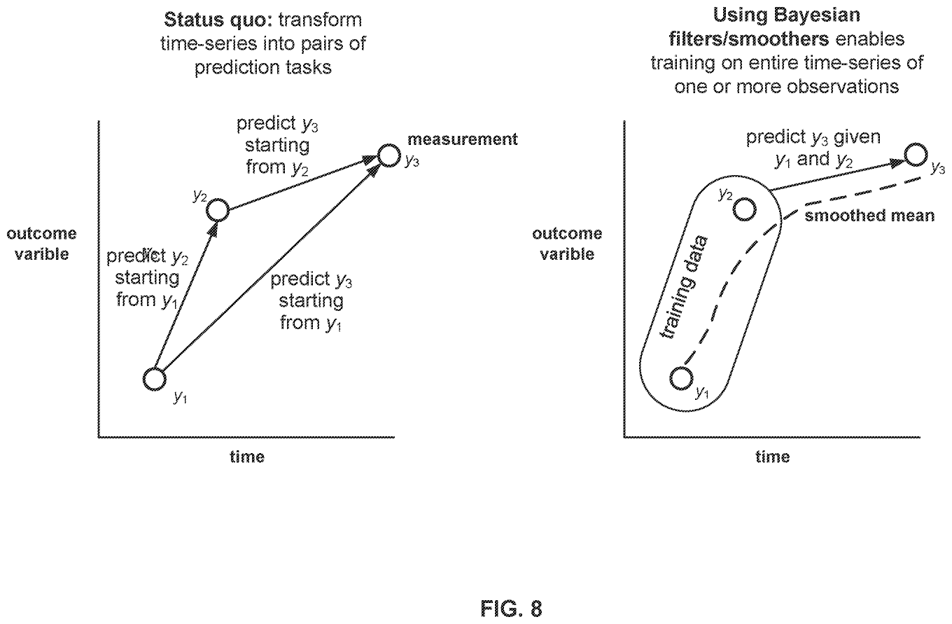

This property of Bayesian smoothing (of reducing uncertainty of early measurements) also makes it useful for decreasing uncertainty about ecosystem attributes and for quantifying impacts of interventions. The prediction of ecosystem attributes in the counterfactual scenario (where the intervention is not applied) is typically made using a simulation starting from the time of the earliest intervention, and Bayesian filtering does not reduce uncertainty at that early point in time when the intervention began. The effects of using Bayesian filters versus a Bayesian smoother are shown in FIGS. 6A and 6B, respectively.

In more detail, Bayesian smoothing incorporates all measurements y_{1:T} and inputs u_{1:T} to compute the conditional probability distribution for the state variables p(zₜ|y_{1:T}, u_{1:T}). One method for doing so is forwards filtering backward smoothing (FFBS), which does a forward pass as in Bayesian filtering, and then it computes a backward pass from time t=T to time t=1, resulting in the integral:

$$\begin{matrix}p ( {z}_{t} \vert {y}_{1 : T} ) = p ( {z}_{t} \vert {y}_{1 : t} ) \int [ \frac{p ( {z}_{t + 1} \vert {z}_{t} ) p ( {z}_{t + 1} \vert {y}_{1 : T} )}{p ( {z}_{t + 1} \vert {y}_{1 : t} )} ] {dz}_{t + 1} \\ = \int p ( {z}_{t} , {z}_{t + 1} \vert {y}_{1 : t} ) \frac{p ( {z}_{t + 1} \vert {y}_{1 : T} )}{p ( {z}_{t + 1} \vert {y}_{1 : t} )} {dz}_{t + 1}\end{matrix}$$

### Methods for Doing Posterior Inference of the Latent States z_{1:T}

Given either point-estimates or a distribution over the noise variances Qₜ and Rₜ and any parameters that exist in the dynamics function ƒ and observation function g, next some methods for doing posterior inference of the latent states z_{1:T} are shown. Later, how to estimate those parameters Qₜ and Rₜ and parameters of ƒ and g is shown.

### Example 2: Linear Gaussian State-Space Models (LG-SSM)

A well-known special case is when the dynamics ƒ and the observation function h are both linear, and the distributions are all Gaussian. Then the filtering and smoothing equations have closed-form solutions found in many texts. This method is useful if the dynamics and observation functions are linear, but that is generally not the case for modeling ecosystem attributes like carbon stocks in soils or forests.

### Example 3: Linear Approximations of Nonlinear Models [Extended Kalman Filter (EKF) and Smoother (EKS)]

Many models of ecosystem attributes are nonlinear, so the dynamics ƒ is a nonlinear function. The Extended Kalman Filter (EKF) and Extended Kalman Smoother (EKS) build a Taylor approximation to the nonlinear model and observation function h, and then they pass Gaussian distributions through these linearized functions and apply the equations of the Kalman filter/smoother. However, this method requires computing the Jacobian (i.e., derivatives) of the dynamics model ƒ and observation function h. The linear approximation breaks down, and therefore the Extended Kalman Filter/Smoother behaves badly, when the prior covariance is large and/or highly nonlinear near the current mean.

### Example 4: Unscented Kalman Filter (UKF) and Smoother (UKS)

One way of addressing the shortcomings of the Extended Kalman Filter/Smoother is to approximate the joint distribution of successive latent states given previous observations, p(zₜ₋₁, zₜ|yₜ₋₁) and the joint distribution of latent state and observation given previous observations, p(zₜ, yₜ|yₜ₋₁), by Gaussians, and then to use numerical integration. However, UKF/UKS are slower and require setting three hyperparameters.

### Example 5: Ensemble Kalman Filter (EnKF)

The problem of quantifying ecosystem attributes across time and space is similar to problems in geosciences that led to the Ensemble Kalman Filter (EnKF). This method approximates the belief state p(zₜ|y_{1:t}) using a finite set of samples of the latent state variables, and these samples are updated in a way similar to the Kalman filter. However, this method is limited to filtering (i.e., it doesn't do smoothing), and it is not guaranteed to converge to the true Bayesian posterior even as the number of samples approaches infinity.

### Example 6: Particle Filtering and Smoothing

A way to do posterior inference for state-space models that can approximate an arbitrary posterior distribution is to use a collection of samples called “particles”. Particle filtering enables one to relax the assumption that the posterior distribution has a certain form, such as Gaussian. Drawing from techniques in importance sampling, this method assigns weights to samples. Choices to be made are how to resample to avoid having many particles with negligible weight, and how to propose values of the latent variables zₜ given the history of the latent variables z_{1:t-1} and the history of observations. Particularly promising for quantifying ecosystem attributes are to use adaptive resampling to automatically decide when to resample and to use the unscented Kalman filter on each particle to compute the proposal distribution.

As noted above, Bayesian smoothing is advantageous for ecosystem attributes. Particle smoothing can be done by introducing a backward filtering step.

A challenge with particle filters/smoothers is divergence, when process error becomes very small to observation error. That leads to a “smug” model that ignores measurements. This problem can be overcome manually by tuning the process variance Qₜ, though even better is to infer the value using the methods discussed next.

Learning the Parameters θₜ (Containing Parameters of the Process Error, Measurement Error, Dynamics ƒ, and Measurement h)

State-space models can be sensitive to the parameters of the dynamics function ƒ, the measurement function h, and the parameters of the noise terms (e.g., Qₜ and Rₜ in the case of zero-mean Gaussian error). Collectively, these parameters are grouped into a variable θ, which may depend on time t. Methods like expectation maximization (EM) only give the most likely value of the parameters. But, markets demand accurate predictions. Therefore, it is prudent to do Bayesian inference on those parameters θ. Methods for doing so include variational Bayes EM, blocked Gibbs sampling, and collapsed Markov Chain Monte Carlo that samples p(θ|y_{1:T}) with z_{1:T} marginalized out, using techniques like Hamiltonian Monte Carlo.

Quantify Uncertainty in Measurements that Will be Assimilated with Models

One step toward learning the parameters θ is to choose prior distributions for the measurement error (e.g., Rₜ). This task could be as simple as retrieving specifications from the manufacturer of a device about the expected variability of measurements, for example the standard deviation of measurements. Some measurement methods need calibration, meaning that adjustments to the mapping from the measurement signal (e.g., a spectrogram of a soil sample) to the prediction (e.g., clay content of the soil) need to be made to improve accuracy on a reference set of measurements whose outcomes have been measured used gold-standard methods. Out-of-sample predictive performance from that calibration can be used to quantify uncertainty of measurements. Uncertainty introduced by drift in calibration of a single device can also be quantified by assuming in a statistical model that errors of a device are correlated (e.g., by assuming that errors are a sum of device-level random effect plus a residual error term). Estimating dependence among observations is also important for data collected in an automated way, such as using drones or satellites (discussed more below).

### Choose an Initial Distribution for State Variables of the Model

The model used to predict ecosystem attributes has many state variables, such as the quantities of carbon and nitrogen in various states. These state variables change over time according to the rules of the model (e.g., differential equations or discrete-time dynamical systems). These variables are generally correlated with one another and are not independent. In order to effectively assimilate uncertain measurements with the model, a joint distribution is assumed for the initial conditions of these latent variables, so that predictions about the distribution of those state variables at a future point in time can be made later.

A common method for choosing initial conditions of these internal state variables in ecosystem models is to do a model spin-up, a long simulation of the model that uses assumptions about climatic conditions and human intervention in recent millennia. The spin-up simulation is typically run until the model settles into an equilibrium, or nearly so. These long simulations are expensive to run, making it challenging to make predictions about probability distributions of the conditions at the end of the spin-up. The status quo is to do one spin-up simulation and then quantify uncertainty in subsequent simulations.

To estimate a distribution over the state variables at the end of the spin-up simulation, one can make distributional assumptions about the climatic conditions, human interventions, and other initial conditions and forcing functions of the model. These prior distributions can be chosen based on literature and expert opinion. Because spin-up simulations can be time-consuming and costly, one may prefer to make assumptions about the functional form of the joint distribution of state variables (e.g., multivariate Gaussian), and then do a small number of spin-up simulations and fit the distribution to those results.

### How to Use New Measurements Taken in the Program Quantifying Ecosystem Attributes

Many projects that quantify ecosystem attributes of interest will periodically take measurements and periodically issue certificates for ecosystem attributes (e.g., measure carbon stocks every five years and issue certificates every year). Suppose that a project has issued some certificates for services provided by a particular ecosystem (e.g., a cropland field) based on one or more measurements and a state-space model, and then suppose that a new measurement is later taken. How should the new measurement be used?

A computationally expensive option is to re-fit the entire state-space model with a larger dataset that includes the new sample. This approach would re-compute the probability distribution of the latent states z_{1:T} as well as the parameters Θ of the model function, measurement function, and their noise parameters. This approach may have the benefit of reducing uncertainty and improving accuracy of predictions at locations other than where a new measurement was taken. However, for markets that require expert review of each new fit of all these parameters, this approach may be done infrequently to reduce costs.

Another option is to treat the previous output of the Bayesian filter or smoother as an informed prior, and then to update only the estimates of the latent states z_{1:T} in light of the new measurement. If Bayesian smoothing is used, then this new measurement could not only reduce uncertainty of the latent state close to that measurement in time, but it could also reduce uncertainty of the latent state at earlier times. That can help reduce uncertainty.

### Ecosystem Models in Three-Dimensional Space

Some models of ecosystems services simulate just the dynamics in one spatial dimension (e.g., depth of the soil, depth of the ocean). Others simulate dynamics in three spatial dimensions. For the latter, the 4DVar formulation can be used. Particle filters and particle flow filters can be applied to sample from the posterior. These methods have been widely used in oceanic and atmospheric modeling.

### Inferential Goal 2: Estimating the Causal Impact of Interventions on Ecosystem Attributes

In many ecosystem markets, there is interest in estimating the causal impact of an intervention such as the impact on carbon sequestration from avoiding deforestation, restoring an ecosystem, planting cover crops, or growing new crops. A gold-standard method for doing so is to run field trials that randomly assign the treatment to some units and that assign others as controls. Such trials can be prohibitively expensive, and the controls lessen the value of the ecosystem attributes by withholding an intervention on some land or ocean surface. If, for example, half of land must be reserved as control, that halves the benefits of the intervention.

Another causal inference strategy is to run counterfactual simulations using predictions of what human interventions and management practices would have happened. This counterfactual world cannot be measured, except at the very beginning when the earliest intervention takes place (when the counterfactual world coincides with the observed world for the last time). The inability to take subsequent measurements in the counterfactual scenario has dissuaded people from using data assimilation for quantifying causal impacts on ecosystem attributes. The concern has been that measurements after the earliest intervention can only be taken in the observed scenario, so bias in the model's prediction can only be mitigated in the observed scenario, but not in the counterfactual scenario.

In this section, it is demonstrated how this perceived wisdom has led the field astray, and that assimilating measurements in the observed scenario can be done with guardrails against bias.

### Create New Latent States for the Counterfactual Scenario

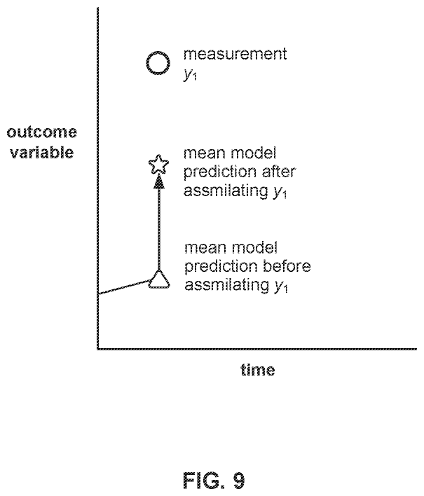

To model the counterfactual, business-as-usual scenario in a state-space model, new hidden states can be created for the counter-factual scenario. These counterfactual latent variables are denoted in the bottom half of FIG. 7 using symbols with a tilde over them. Before the earliest intervention of interest, there is just one sequence of latent variables, and after that intervention there are two parallel sequences of latent variables for the observed scenario and counterfactual scenario. Exogenous covariates (e.g., weather, or management practices or soil properties that are not modified in an intervention) are common to both scenarios. The inputs from humans, denoted by a₃ in FIG. 7, differ between the observed and counterfactual scenarios. These inputs reflect management practices of the ecosystem, such as what species are planted.

FIG. 7 shows a twin network state-space model for estimating causal impact of an intervention that occurs just after time step n=2. There are m=4 actual observations, denoted y_{1:4}. The incoming arcs are cut to z₃ since z_{3:T} is assumed to come from a different distribution, namely the post-intervention distribution. However, in the counterfactual world, shown at the bottom of the figure (with tilde symbols), it is assumed that the distributions are the same as in the past, so information flows along the chain uninterrupted.

To predict what would have happened without the intervention (as denoted by the variable a with the tilde symbol being equal to 0), the part of the model that occurs after the intervention is replicated and used to make forecasts. The goal is to compute the counterfactual distribution shown below, where \tilde{y}ₜ represents counterfactual outcomes if the action had been ã=0:

$$p ( {\tilde{y}}_{n + 1 : m} \vert {y}_{1 : n} , {x}_{1 : m} ) \text{?}$$

$$\text{?} \text{indicates text missing or illegible when filed}$$

The causal impact of some intervention can then be computed by comparing the ecosystem attribute predicted by counterfactual latent states with the ecosystem attribute predicted by the latent states reflecting the impact the intervention.

### Bayesian Smoothing Reduces Uncertainty of the Initial State at the Time of the Intervention

The latent states post-intervention are assumed to depend on the latent state immediately preceding the intervention (recall the definition of the state-space models considered here at the top of this document). Also, as noted above, using Bayesian smoothing makes one more confident about early latent states by doing backwards filtering using subsequent measurements. Thus, with smoothing, measurements taken after the intervention in the observed scenario (ã=1) can decrease uncertainty of counterfactual outcomes in the unobserved scenario (ã=0). To realize this decrease in counterfactual outcomes \tilde{y}ₜ, the forwards filtering backward smoothing (FFBS) algorithm is modified to do a second filtering step, but this time applied to the counterfactual latent states \tilde{z}ₜ.

Accordingly, Bayesian smoothing not only reduces uncertainty of early states of the ecosystem but also of counterfactual states of the ecosystem.

Using Field Trials with Controls to Quantify Out-of-Sample Predictive Accuracy

In some cases, field trials are accessed, in which interventions were done to part of an ecosystem (ideally chosen in a randomized way) and the remaining parts were left as controls. It is common to use such trials to fit models that simulate the ecosystem on part of this dataset and to check that bias is negligible on the held-out portion of the dataset. This process of choosing a hold-out set can be repeated, a technique that is called cross validation.

The model is typically initialized using an initial measurement, and the task is to predict the ecosystem attribute of interest at some later date (e.g., initialize with the carbon stock of the soil, and predict the carbon stock of the soil at a later date). When three or more measurements are available, the typical method has been to divide the measurements into multiple pairs of initial measurement and subsequent measurement, as depicted in FIG. 8A. FIG. 8B depicts the use of Bayesian filters and smoothers, which can use not only an initial measurement but also subsequent measurements as inputs to the prediction.

Datasets from field trials can be deployed in the state-space approach described in this document. As in the status quo approach, one can fit the state-space model to a portion of the field trials (the “training set”), and then do Bayesian smoothing when deploying the state-space model on the held-out data. What is new with the state-space approach is that one can feed in entire time-series of measurements, rather than just the initial measurement, as depicted in the FIG. 8. Diagnostics can be computed about the model's ability to predict the ecosystem attribute of interest at some later date.

Accordingly, Bayesian filtering/smoothing enables improving predictions using measurements of the ecosystem taken after the initial measurement, whereas status quo methods cannot exploit subsequent measurements. The out-of-sample performance can be evaluated using cross-validation.

Mitigating Bias Introduced from Assimilating Data Only in the Observed Scenario, but not the Counterfactual, by Building on the Idea of Smoothing

By doing cross-validation experiments to quantify the out-of-sample accuracy, one can numerically check whether assimilating measurements in the observed scenario are eliminating bias in the observed scenario but not eliminating bias in the counterfactual scenario.

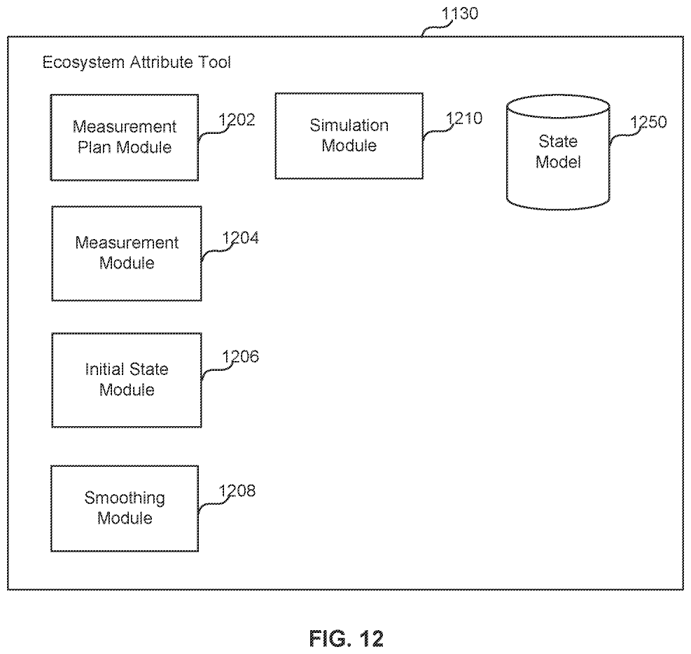

For example, suppose the outcome variable and measured quantity is carbon stocks, and suppose the method begins by assimilating a model's spin-up with an initial measurement. After assimilating the measurement with a model, the posterior predictive mean is closer to the measurement by an amount that depends on the model uncertainty and measurement uncertainty, as shown in FIG. 9.

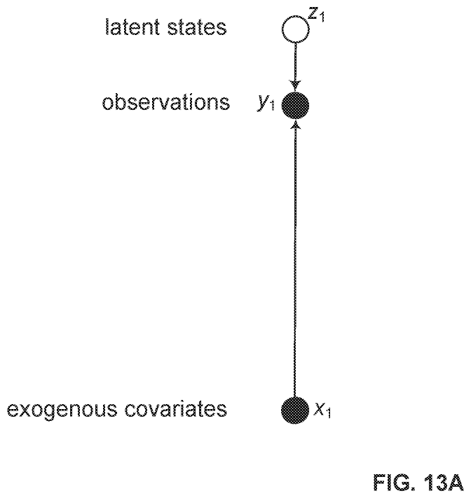

Next, suppose an intervention occurs soon after the measurement y₁ is taken, and then a second measurement y₂ is taken a significant amount of time later. That measurement is assimilated with the model's prediction of the observed scenario, and it reduces the bias of the model in the observed scenario for predictions at and after that second measurement is taken. No such subsequent measurement is available for the counterfactual scenario, so it can only be imagined what hypothetical measurement would have been obtained (as indicated by the dotted circle in FIG. 10). Assimilating subsequent measurements in the observed scenario may mitigate model errors in the observed scenario, but not in the counterfactual scenario because the counterfactual cannot be directly measured (see the notes next to the leftward-pointing curly braces in FIG. 10). If the model has a systematic bias present in both scenarios, that bias may no longer cancel when subtracting the outcome variable in the observed and counterfactual scenarios, resulting in the causal impact of the intervention being over-estimated.

This bias introduced by assimilating data in the observed scenario can be numerically quantified in the cross-validation exercise using field trial data. As noted above, it is recommended to use a Bayesian smoother, not a Bayesian filter, to improve the prediction of the initial state using the subsequent measurement, to reduce uncertainty about early states and to, by extension, reduce uncertainty of counterfactual states. One can compare the results with an experiment that does not assimilate subsequent measurements y₂, y₃, . . . , to see if assimilation may be introducing an error in the causal impact.

If assimilation does appear to mitigate a model bias in just the observed scenario, the model ƒ could be modeled by fitting statistical models to residuals using variables that may be predictive of model bias (e.g., sand content of the soil, mean annual precipitation). Once predictive models of the residual are found, modify ƒ by adding that predictive model of the residuals, and then repeat the cross-validation exercise to see if it eliminates the bias in the estimated causal impact of the intervention. This approach has the advantage of mitigating bias in the causal impact of the intervention.

### Measurements of Many Distinct Variables, Using Many Different Measurement Methods, can be Assimilated

Two advantages of the state-space modeling approach described here are that it enables a wide variety of variables to be measured and assimilated with the model, and it enables multiple measurement methods to be used.

### Assimilating Measurements of Multiple Distinct Variables

There may be multiple attributes of the ecosystem that can be predicted from the model's latent state z and compared with measurements via a measurement function h. For example, in agricultural cropland or rangeland, one may measure the carbon stock of the soil and compare it with the sum of the stocks in the model's carbon pools.

One may also compare yield (of grain or fiber) reported by the land manager with the yield implied by the plant growth simulated by the model. Both such measurements may be assimilated with the model, thereby helping to reduce uncertainty of the model's latent states z and improve accuracy of variables that can be predicted from the latent state, such as yield or carbon stocks.

Importantly, the measured quantity need not be directly related to the ecosystem attribute of interest. For example, measurements of harvest yield can improve the model's predictions of carbon stocks. The reason is the Bayesian filter/smoother infers covariance among latent variables, and the latent variables related to the measurement (i.e., the entries in z on which the measurement function h depends) may be correlated with other latent variables that are more directly related to the ecosystem attribute of interest.

Accordingly, even measurements of quantities that are only indirectly related to the ecosystem attribute of interest can improve accuracy for that ecosystem attribute of interest, due to covariance inferred among latent variables.

Assimilating Measurements Taken with Different Methods, Including Ones with lots of Measurement Uncertainty

Another advantage of the approach proposed here is that one can assimilate multiple measurement methods, each with their own measurement uncertainty. That is, the measurement variance Rₜ can vary with the measurement method used, and the bias of the measurement could also be modeled.

This capability is an improvement over the status quo in the quantification of ecosystem attributes. Many methodologies for ecosystem attributes treat measurements as truth, with zero uncertainty. The rationale has been that if adequate processes for quality control are in place, then the results can be trusted. This thinking has hampered progress. There are a large number of new technologies for measuring ecosystem attributes (including spectroscopy, low-cost embedded sensors, sensors driven across soil, remote sensing). But these technologies have, to a large extent, not been used in markets because they are deemed too noisy or they give too little information (e.g., they measure just the top layer of soil or just the canopy). Lacking solutions that incorporate uncertainty of measurements, these markets remain wedded to expensive, “gold standard” methods of measurement.

With the methods presented here, one can, for example, take initial measurements with a gold-standard method that has low measurement error variance, and then in subsequent measurements switch to a low-cost method that has large measurement error variance. The Bayesian filter/smoother makes a smaller update when assimilating a measurement with large error variance, reflecting the intuitive idea that one is more skeptical of such a measurement.

Some of these measurement methods can have non-negligible correlated errors due to errors in calibration of the devices or sensitivity to conditions on the day of the measurement. These correlated errors can be modeled by relaxing the assumption that measurement errors have zero mean, and the measurement bias can be one of the parameters in θ that is learned jointly with other parameters (as discussed above).

### Computational Runtime

Doing Bayesian smoothing on long sequences of measurements (i.e., with large T) can be time-consuming. Kalman smoothing, for example, takes O(N_{y}³+N_{z}²+N_{y}N_{z}) runtime per T time-steps (where N_{y} and N_{z} are the lengths of the vectors y and z, respectively), though this runtime can be reduced to O(log T) steps using an algorithm that can run on GPUs.

Bayesian filters/smoothers can be run on CPUs, GPUs, or TPUs using computing libraries like JAX. An example is DYNAMAX, a library of state space models that uses JAX.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

### Counterfactual Simulation for Interventions—Detailed Description

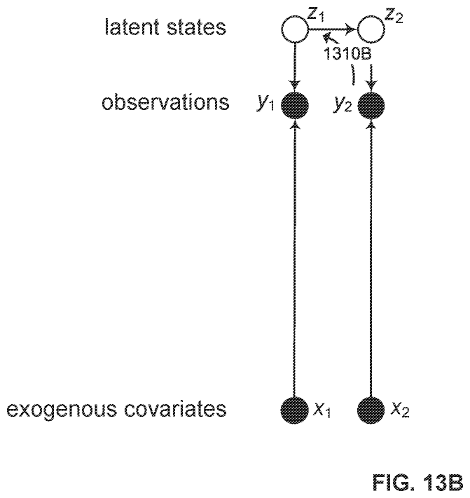

FIG. 11 illustrates one embodiment of a system environment for implementing an ecosystem attribute tool, in accordance with an embodiment. FIG. 11 depicts environment 1100, having client device 1110, sensors 1115, network 1120, and ecosystem attribute tool 1130. Client device 1110 may be any device having a user interface for a user requesting performance of any functionality disclosed herein, such as requesting sensor measurements, ecosystem attribute determinations, and so on. Client device 1110 may be any device such as a smartphone, personal computer, tablet, kiosk, wearable (e.g., smart watch), and so on. Sensors 1115 may include sensors for measuring ecosystem attributes. The sensors may perform direct measurement (e.g., direct measurement of soil carbon), indirect measurement (e.g., remote sensing by a satellite that captures images, which in turn are used to determine measurements), and so on. The number of sensors and client devices depicted in environment 1100 is merely for convenience, and any number of sensors and client devices may be present in environment 1100 for performing any functionality disclosed herein.

Network 120 is a communication medium between client device 110, sensors 115, and ecosystem attribute tool 130. Network 120 may include any form of medium for facilitating electronic communications between devices, such as the Internet, Wi-Fi, a local area network, a wide area network, a short range link, and so on. Ecosystem attribute tool 130 determines ecosystem attributes for geographical regions, and in some embodiments performs simulations to determine counterfactual states where interventions occurred in order to estimate an observation had the intervention not occurred. Further details regarding the components of environment 100 are described above and below with reference to the other figures of this disclosure.

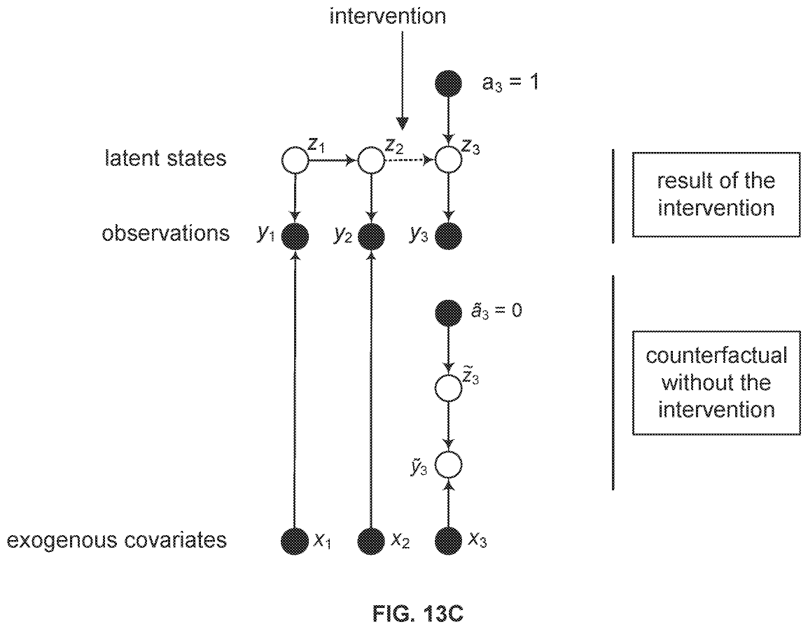

FIG. 12 illustrates one embodiment of exemplary modules and databases used by the ecosystem attribute tool, in accordance with an embodiment. As depicted in FIG. 12, ecosystem attribute tool 1130 includes Measurement plan module 1202, measurement module 1204, state module 1206, smoothing module 1208, simulation module 1210, and state model database 1250. The modules and databases depicted in FIG. 12 are merely exemplary, and any number of modules and/or databases may be used to achieve the functionality disclosed herein.

Measurement plan module 1202 determines that a measurement for a geographic region is to be performed. The geographic region may be any discrete area, such as a field, farm plot, forest plot, or other geographic region of interest having qualities to be measured. Measurement plan module 1202 may determine that one or more measurements are to be performed based on input from client device 110 (e.g., an explicit instruction to take measurements). Measurement plan module 1202 may determine that one or more measurements are to be performed based on detecting that a condition is met. The condition may be an agronomic practice (e.g., determine that given species are planted within the geographic region and, for each of the given species, determine a predefined cadence by which to measure, where update module determines that a next time to measure has been reached). The condition may be that a change in an exogeneous covariate (e.g., weather) is detected by measurement plan module 1202, such as a rainstorm has stopped, started, or has ended a predefined amount of time in the past. The condition may be that the process variance at a certain location has exceeded a threshold. Exogeneous covariates are characteristics of an environment to be modeled that are common to both an intervention and counterfactual scenario (e.g., weather). Exogeneous covariates may include management practices for a geographic region, soil properties that are not modified in an intervention, and any other common characteristic to the two scenarios.

Measurement module 1204 obtains measurements at each time instructed by measurement plan module 1202. Measurement module 1202 may obtain measurements by activating one or more of sensors 115 and/or by prompting one or more users (e.g., using a user interface of client device 110) to perform measurements. Measurements may be for any value relating to a geographical region, such as soil carbon measurements of any type (e.g., dry combustion), nitrogen pool measurements, and so on. Measurements may be performed as a derivative from output of sensors 115 (e.g., in the remote sensing scenario, where the sensors provide images from which measurements may be derived). Measurements may directly or indirectly result in a value for an ecosystem attribute. An example of a direct measurement of an ecosystem attribute may be a sensor that directly measures soil organic carbon levels. Indirect measurements may be values that are correlated with a characteristic of an ecosystem, such as crop yield, reflections from ground penetrating radar, changes from apparent electrical conductivity from electromagnetic induction sensors, and so on. Measurements may be taken before, during, and/or after an intervention.

Measurement module 1204 estimates the uncertainty of the measurement taken (e.g., the standard deviation of repeated measurements). The estimate may be assumed to be a constant that depends on the measurement type chosen (e.g., the instrument's manufacturer reports the precision of the instrument). The estimate may be estimated in the process of taking the measurement (e.g., by calculating the standard deviation of replicate measurements).

In some embodiments, measurement module 1204 may dynamically determine which of sensors 115 to activate in order to measure a given ecosystem attribute. For example, different sensors may have different levels of precision, with respective levels of uncertainty around the measurements made using those sensors. Different sensors also have different practical constraints, where some may be computationally expensive or otherwise impractical to deploy, and others may be computationally inexpensive and easy to deploy but may be imprecise. Measurement module 1204 may determine an optimization that employs a minimum acceptable level of uncertainty, where a least computationally expensive sensor is used that has at least the minimum acceptable level of uncertainty. This is enabled based on the Bayesian smoothing process, which accounts for uncertainty levels when determining a more accurate range of likely values using a model.

Measurements may be representative of a discrete moment in time, or may be representative of a range of time. References of measurements taken “for a time” (or similar) may represent measurements taken for a range of time. For example, satellite data, weather data, soil data, and so on may reflect information for a range of time associated with each particular data type. A range of time may be any useful amount of time, such as a day, a week, a month, a crop year, a harvest range, and so on, and may be informed by current and historical datasets.

In order to optimize, measurement module 1204 may determine a maximum level of uncertainty for a given measurement. The maximum level of uncertainty may be any level of tolerance, and may be a default value or may be defined by a user. Predefined maximum levels of uncertainty may be defined for different scenarios, and measurement module 1204 may refer to an index mapping characteristics of candidate scenarios to respective maximum levels of uncertainty to select a corresponding maximum level of uncertainty. Measurement module 1204 may determine a sensor requiring a lowest amount of processing power of respective processing power of each respective sensor of a plurality of candidate sensors that has at most the maximum level of uncertainty. For example, measurement module 1204 may query an index that maps the processing power and the uncertainty level for each respective sensor and determine relative values for each candidate sensor for the given measurement. Measurement module 1204 may then select the sensor requiring the lowest amount of processing power to obtain the given measurement.

Initial state module 1206 may determine a probability distribution of initial conditions of the internal states of the model before measurements are taken. The characterization of the probability distribution can take one of multiple forms, including Monte Carlo draws from the probability distribution, or moments of the probability distribution (e.g., mean, variance, and skew), or a discrete approximation of the cumulative distribution function. Initial state module 1206 may transform estimates of historical fire-return intervals, historical climate, etc., into such a probability distribution over the latent states of the model.

Smoothing module 1208 performs a smoothing (e.g., a Bayesian smoothing) to update latent states of a model given measurements that are taken. The inputs to the smoothing module 1208 are the estimates of the uncertainty of the measurement from measurement module 1204 and the estimates of the uncertainty of the measure variable from the simulation module 1210. The output of smoothing module 1208, for each attribute measured, is an update to the latent states of the Simulation Module 1210 and to the representation of the uncertainty of those latent states (e.g., to the moments of their distributions, or to the particles that represent random draws). Smoothing module 1208 achieves smoothing by performing the functionality described above with respect to FIGS. 2-6.

Simulation module 1210 performs a simulation of a model over time. This module updates the internal states of the model repeatedly for a given amount of time steps. Simulation Module 1210 records its state variables in the State Model database 1250. Simulation Module 1210 predicts the observed variable(s) using measurement function(s) (e.g., the measurement function may sum the carbon pools [latent state variables] to predict the total carbon stock [the measured variable]).

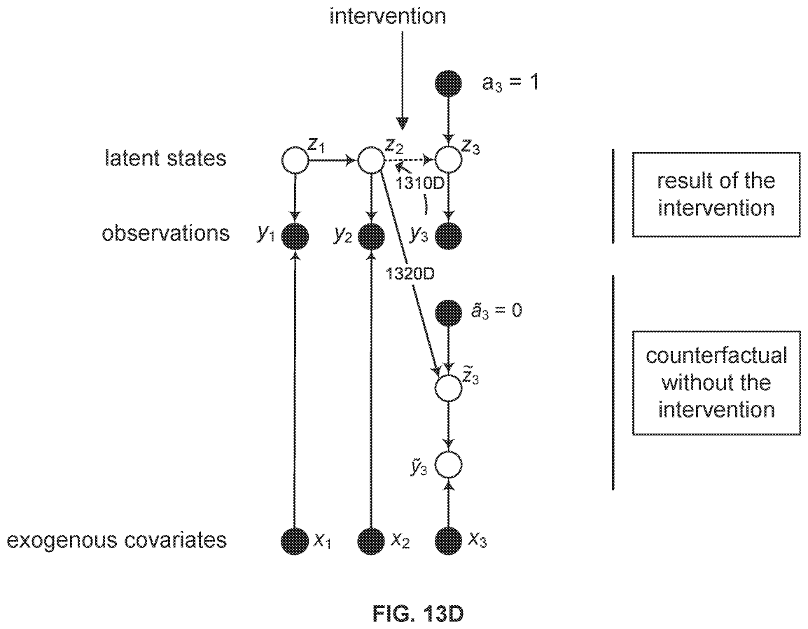

In order to better illustrate the activity of simulation module 1210, we turn to FIG. 13. FIGS. 13A-D are a sequential illustration of a model using a counterfactual and intervention with smoothing applied between steps of the sequence, according to embodiments of the present disclosure. FIGS. 13A-D flesh out a sequence described with respect to FIG. 7 above, and for brevity portions already described with respect to FIG. 7 may be omitted here, but carry full force with respect to FIG. 13 wherever omitted.

As depicted in FIG. 13A, at time step t=1, the probability distribution for the latent state z₁ is determined by the Initial Condition Module 1202. The measurement module 1204 decides that a measurement should be taken at time t=1. The measurement module 1204 produces an estimate of the measured variable y₁ and an estimate of uncertainty of that measurement. The measurement y₁ is provided to the smoothing module 1208 to update the probability distribution for the latent state z₁ of the model. The Simulation Module simulates the probability distribution for the measurement y₁ based on the probability distribution of the latent state z₁, the exogenous variables x₁, and the measurement function (denoted by H in FIG. 4). The smoothing module compares the probability distribution of the prediction of y₁ with the probability distribution of the measurement of y₁ and updates the probability distribution for the latent state z₁ (e.g., using the method described with respect to FIGS. 6A and 6B. Moving now to FIG. 13B, the same process is used to measure and predict y₂ at time step t=2. This time, however, the smoothing module 1208 updates both the latent states z₂ and z₁. This ensures that latent states are informed by future observations, enabling prior estimations to be improved.

Turning to FIG. 13C, an intervention is applied at time step t=2. Simulation module 1210 now simulates the ecosystem twice: once to simulate the counterfactual latent states \tilde{z}ₜ (and the associated counterfactual observations \tilde{y}ₜ) and once to simulate the latent states zₜ in the observed world where the intervention is applied (and the associated observations yₜ).

Turning now to FIG. 13D, smoothing module 1208 updates counterfactual latent states z₁, z₂, and z₃ by conditioning on the observation y₃. The refined latent states z₂ are then used to refine 1320D counterfactual latent states \tilde{z}₃. In this way, counterfactual latent states are informed by actual measurements through this feedback loop. Such feedback can be utilized by simulation module 1210 at subsequent time steps (\tilde{z}₄, \tilde{z}₅, etc.). Any number of interventions may be accounted for along with their counterfactual scenarios in this way.

Simulation module 1210, having obtained actual and counterfactual latent states for certain time steps, may calculate an outcome variable of interest given those latent states (e.g., compute the total carbon stock by summing the latent states that correspond to the stocks of carbon in various forms). Then a difference in that outcome variable between the actual and counterfactual scenarios can be calculated. This difference represents an impact of having performed the intervention. For example, where a cover crop is planted as an intervention, the impact on soil carbon may be measured by using this difference. Simulation module 1210 may feed this simulated impact into any other downstream calculation (e.g., of carbon credits).

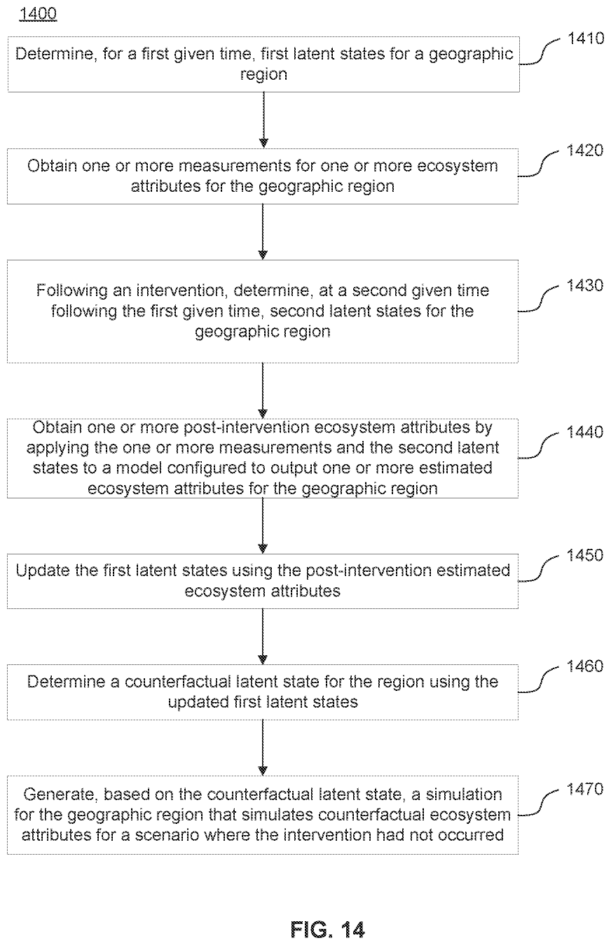

FIG. 14 is an illustrative flowchart showing a process for estimating ecosystem attributes, in accordance with an embodiment. Process 1400 may be performed by ecosystem attribute tool 1130 having one or more processors execute instructions stored in memory of a non-transitory computer-readable medium. Process 1400 may begin with ecosystem attribute tool 1130 determining 1410, for a first given time, first latent states for a geographic region (e.g., using state initial state module 1206). The first time need not precede all interventions, but may instead be any arbitrary time preceding a next intervention of interest. Ecosystem attribute tool 1130 may obtain 1420 one or more measurements for one or more ecosystem attributes for the geographic region (e.g., using measurement module 1204). Measurements may be obtained before, during, and/or after an intervention.

Following an intervention, ecosystem attribute tool 1130 may determine 1430, at a second given time (e.g., time range) following the first time, second latent states for the geographic region (e.g., using initial state module 1206). Ecosystem attribute tool 1130 may obtain 1440 post-intervention ecosystem attributes by applying the one or more measurements and the second latent states to a model configured to output estimated ecosystem attributes for the geographic region (e.g., using a state model such as DayCent, stored in state model database 1250). Ecosystem attribute tool 1130 may update 1450 the first latent states using the post-intervention estimated ecosystem attributes (e.g., using smoothing module 1208), and may determine 1460 a counterfactual latent state for the region using the updated first latent states. Ecosystem attribute tool 1130 may generate 1470, based on the counterfactual latent state, a simulation for the geographic region that simulates counterfactual ecosystem attributes for a scenario where the intervention had not occurred.

By simulating counterfactual ecosystem attributes using the mechanisms described herein, a more robust data pool is leveraged that not only accommodates higher uncertainty measurements at a given timepoint (or range), thus unlocking large efficiency gains, but also allows use of measurements from otherwise incompatible time points. Traditionally, process models like DayCent take a measurement of a given ecological attribute (e.g., the initial soil carbon stock) as an input, and they simulate forward in time from that starting point. Crude methods may be used to “re-initialize” the given ecological attribute (e.g., soil carbon pool) in the model to the measured value, by overwriting their values, thereby causing a loss of data. And when a follow-up measurement of the given ecological attribute (e.g., soil carbon) is taken years later, the status quo method is to just calibrate the model anew with these measurements added to the training dataset, resulting in yet further loss of data. This results in inefficiencies where sensors are activated, but their measurements are then discarded.

Bayesian smoothing, as used in the manner disclosed herein, solves these shortcomings in a variety of manners. The systems and methods disclosed herein allow for “Back-modeling” to the start of the project scenario. That is, it is operationally difficult to measure a given ecological attribute exactly on the date when, according to rules in a carbon methodology imposed by the carbon registry, carbon credits begin to be generated (e.g., the day after the latest harvest preceding the earliest intervention in that field). In practice one takes a measurement as much as a year later. One wishes to somehow use a process model to predict the carbon stock on that particular date.

Naïve approaches might include to (a) assume your initial measurement is a good estimate of the measurement of interest (despite occurring months later, potentially introducing a large error due to seasonal changes) or to (b) brute-force run the process model on many initial values and find the one(s) whose simulation is closest to your measured value. Approach (a) is undesirable because one would miss out on months of carbon stock change. Approach (b) fixes that, but it does not take into account uncertainty of the measurement. The systems and methods disclosed herein employ Bayesian smoothing in a way that solves this problem in a more effective way by taking into account uncertainty of the measurement (something ignored by both of the aforementioned naïve approaches). And unlike the approach of just using an initial measurement, the systems and methods disclosed herein take into account seasonal fluctuations in ecological attributes, thereby avoiding sizeable errors.

The systems and methods disclosed herein involve a better use of initial measurements, leading to greater accuracy. The status quo of overwriting the variables in the model so that the model's, e.g., soil carbon stock exactly equals the measured soil carbon stock, can lead to inaccurate predictions. One reason for such in accuracies is that other internal state variables updated (e.g., soil N content, plant growth, etc.) are not updated, so the internal state variables can become unrealistic. For example, suppose internal variables X1 and X2 tend to negatively covary, and the status quo updates X1 downward but does not touch X2, leading to an unrealistic positive correlation between X1 and X2). Another reason is that information in the spin-up simulation is ignored, yet the spin-up simulation has value in providing skepticism about the measurement.

The systems and methods disclosed herein result in operational flexibility in timing of measurements. The status quo in, e.g., the soil science community is a dogmatic belief that one should always take measurements of soil carbon stocks at the same time of the year. That is, if an initial measurement in Field 1 is in mid-April, the second measurement in Field 1 should be taken in mid-April (plus or minus a couple weeks). The rationale is that soil carbon stocks fluctuate seasonally, and one wants to avoid confusing a seasonal fluctuation for a long-term trend. Adhering to this rule of thumb is operationally difficult; as a result, fewer samples are taken, and uncertainty is higher.

The systems and methods disclosed herein remove this constraint on when to take follow-up measurements. This may avoid inefficiencies where it is logistically difficult to deploy sensors for measurement in narrow time windows. Instead, the systems and methods disclosed herein may activate sensors for measurement of, e.g., soil carbon at whatever date is operationally convenient (when crops are not tall, weather cooperates, staffing is available, etc.). In practice, we almost always find ourselves wanting to estimate and report carbon offsets generated up to a date after the date of our follow-up measurement (potentially months or years afterward). By assimilating the follow-up measurement with the process model, the systems and methods disclosed herein use the follow-up measurement to improve the prediction of the stock at the date of interest. And this method is robust to having the initial and follow-up measurement taken at different times of the year: the model knows about seasonal fluctuations, so those fluctuations are taken into account when assimilating the measurement.

What is claimed is:

1. A method for estimating ecosystem attributes, the method comprising:
determining, for a first given time, first latent states for a geographic region;
obtaining one or more measurements for one or more ecosystem attributes for the geographic region;
following an intervention, determining, at a second given time following the first given time, second latent states for the geographic region;
obtaining one or more post-intervention ecosystem attributes by applying the one or more measurements and the second latent states to a model configured to output one or more estimated ecosystem attributes for the geographic region;
updating the first latent states using the post-intervention estimated ecosystem attributes;
determining a counterfactual latent state for the region using the updated first latent states; and
generating, based on the counterfactual latent state, a simulation for the geographic region that simulates counterfactual ecosystem attributes for a scenario where the intervention had not occurred.

2. The method of claim 1, wherein the model is further configured to take exogenous covariates as further input in order to output the estimated ecosystem attributes for the geographic region.

3. The method of claim 1, wherein determining the first latent states for the geographic region comprises:
determining a characterization of a probability distribution for latent states of the model; and
obtaining values for the first latent states by running the model on the characterization of the probability distribution.

4. The method of claim 1, wherein generating the simulation comprises estimating an impact of the intervention.

5. The method of claim 4, wherein estimating the impact of an intervention comprises determining a difference between the counterfactual ecosystem attributes and the post-intervention ecosystem attributes.

6. The method of claim 1, wherein the model is configured to output a probability distribution over the estimated ecosystem attributes based on a probability distribution over the latent states.

7. The method of claim 1, wherein the intervention comprises an activity that affects an ecosystem attribute within the geographic region.

8. The method of claim 1, wherein obtaining the one or more measurements comprises:
determining a maximum level of uncertainty for the measurements;
determining a sensor requiring a lowest amount of processing power of respective processing power of each respective sensor of a plurality of candidate sensors that has less than the maximum level of uncertainty; and
selecting the sensor requiring the lowest amount of processing power to obtain at least a portion of the one or more measurements.

9. The method of claim 1, further comprising further updating the updated first latent states based on one or more of further measurements for a set of ecosystem attributes.

10. The method of claim 1, wherein one or more of obtaining one or more measurements for an ecosystem attribute or an exogeneous covariate comprises application of a machine learned model to satellite imagery.

11. The method of claim 1, wherein the one or more ecosystem attributes of the one or more measurements comprise an ecosystem attribute that differs from one or more of the estimated ecosystem attributes and counterfactual ecosystem attributes.

12. A non-transitory computer-readable medium comprising memory with instructions encoded thereon for estimating ecosystem attributes, the instructions, when executed, causing one or more processors to perform operations, the instructions comprising instructions to:
determine, for a first given time, first latent states for a geographic region;
obtain one or more measurements for one or more ecosystem attributes for the geographic region;
following an intervention, determine, at a second given time following the first given time, second latent states for the geographic region;
obtain one or more post-intervention ecosystem attributes by applying the one or more measurements and the second latent states to a model configured to output one or more estimated ecosystem attributes for the geographic region;
update the first latent states using the post-intervention estimated ecosystem attributes;
determine a counterfactual latent state for the region using the updated first latent states; and
generate, based on the counterfactual latent state, a simulation for the geographic region that simulates counterfactual ecosystem attributes for a scenario where the intervention had not occurred.

13. The non-transitory computer-readable medium of claim 12, wherein the model is further configured to take exogenous covariates as further input in order to output the estimated ecosystem attributes for the geographic region.

14. The non-transitory computer-readable medium of claim 12, wherein the instructions to determine the first latent states for the geographic region comprise instructions to:
determine a characterization of a probability distribution for latent states of the model; and
obtain values for the first latent states by running the model on the characterization of the probability distribution.

15. The non-transitory computer-readable medium of claim 12, wherein the instructions to generate the simulation comprise instructions to estimate an impact of the intervention.

16. The non-transitory computer-readable medium of claim 15, wherein estimating the impact of an intervention comprises determining a difference between the counterfactual ecosystem attributes and the post-intervention ecosystem attributes.

17. The non-transitory computer-readable medium of claim 12, wherein the model is configured to output a probability distribution over the estimated ecosystem attributes based on a probability distribution over the latent states.

18. The non-transitory computer-readable medium of claim 12, wherein the intervention comprises an activity that affects an ecosystem attribute within the geographic region.

19. The non-transitory computer-readable medium of claim 12, wherein the instructions to obtain the one or more measurements comprise instructions to:
determine a maximum level of uncertainty for the measurements;
determine a sensor requiring a lowest amount of processing power of respective processing power of each respective sensor of a plurality of candidate sensors that has less than the maximum level of uncertainty; and
select the sensor requiring the lowest amount of processing power to obtain at least a portion of the one or more measurements.

20. A system for estimating ecosystem attributes, the system comprising:
memory with instructions encoded thereon; and
one or more processors that, when executing the instructions, are caused to perform operations comprising:
determining, for a first given time, first latent states for a geographic region;
obtaining one or more measurements for one or more ecosystem attributes for the geographic region;
following an intervention, determining, at a second given time following the first given time, second latent states for the geographic region;
obtaining one or more post-intervention ecosystem attributes by applying the one or more measurements and the second latent states to a model configured to output one or more estimated ecosystem attributes for the geographic region;
updating the first latent states using the post-intervention estimated ecosystem attributes;
determining a counterfactual latent state for the region using the updated first latent states; and
generating, based on the counterfactual latent state, a simulation for the geographic region that simulates counterfactual ecosystem attributes for a scenario where the intervention had not occurred.
